(19) United States
(12) Patent Application Publication
(10) Pub. No.: US 2007/0076424 A1
(43) Pub. Date: Apr. 5, 2007

(54) Backlight module

(75) Inventor: Chia-Yin Chang, Kaohsiung (TW)

Correspondence Address: LEONG C LEI, PMB # 1008, 1867 YGNACIO VALLEY ROAD, WALNUT CREEK, CA, 94598, US

(73) Assignee: RADIANT OPTO-ELECTRONICS CORPORATION

(21) Appl. No.: 11/240,506

(22) Filed: Oct. 3, 2005

(51) Int. Cl. G09F 13/00

(52) U.S. Cl. 362/551

(57) ABSTRACT

A backlight module device is disclosed. The module comprises lighting tube and light conductive panel having a light coupling device therebetween. The light-receiving end plane of the light coupling device is at least a non-vertical plane so that the light source from the tube, via refraction, changes its direction at the light-incident light-field distribution of the light-conductive panel. This will reduce the loss of light source when the light source passes through the reverse light incident end plane such that the light source is fully utilized.

### BACKGROUND OF THE INVENTION

(a) Technical Field of the Invention

The present invention relates to backlight module, and in particular, a backlight module, which can change the incident light light-field distribution of light, source at the light-conductive panel.

(b) Description of the Prior Art

FIG. 1 is a backlight module 1 comprising a light-conductive panel 11, a light reflective sheet 12, a plurality of light diffusion lenses 13, a plurality of focusing lenses 14 and a light bulb 15. The light conductive panel 11 has a light-emitting plane 111, a reflective plane 112 and at least a light-incident end plane 113. The reflective sheet 12 is mounted at the external surface of the reflective plane 112 of the light-conductive panel 11. The light diffusion lenses 13 is located at the surface of the light-emitting plane 111 at the light-conductive panel 11. The plurality of focusing lenses 14 is mounted on the other plane of the diffusion lenses 13, and the light diffusion lenses 13 and the light-focusing lenses 14 can be mounted alternately.

The light-bulb 15 is mounted on the external surface of the light-emitting end face 113 of the light-conductive panel 11, and a light reflector 16 to enclose the light bulb 15.

The material of the light conductive panel 11 is optical acrylic (PMMA) which has an advantage of light transitivity, and the light reflective plane 112 is provided with a plurality of light-conductive points 1121, and the light conductive points 1121 are arranged from small to large in accordance with the distance of the light source, or are arranged from less densely configuration to dense configuration.

As shown in FIG. 2, after the light bulb 15 is supplied with power, a light source will be emitted and travel from the incident end face plane 113 into the interior of the light-conductive plane 11. The light source from the interior of the light-conductive panel 11 is reflected by the light-conductive points 1121 and is emitted from the light emitting plane 111. However, the light bulb 15 is located in parallel at the exterior of the incident end face 113 of the light-conductive panel 11. Thus, when light source enters the interior of the light conductive panel 11, the incident angle is smaller than the critical angle of the total reflection.

Thus, although a partial of light source is reflected to provide light via the light-conductive point 1121 of the reflective plane 112 of the light conductive panel 11, but a major portion of the light source travels in a horizontal direction and is leaked at the anti-emitting end plane 114, and therefore there is an exhaustion of light energy.

In recent years, the application of TFT-LCD is wide and the application of TFT-LCD with light source of backlight module 1 is very strict and the drawbacks that mentioned above have to be overcome.

### SUMMARY OF THE INVENTION

The primary purpose of the present invention is to provide a backlight module, and in particular, a backlight module which can change the incident light light-field distribution of the light source into the light conductive panel so as to reduce the drawback of the light source leaked from the anti incidence end face of the light-conductive panel.

Yet another object of the present invention is to provide A backlight module device comprising a light conductive panel having a light-emitting plane, a light reflective plane corresponding to the position of the light-emitting plane; and at least a light-incident plane; a reflective sheet arranged on the external surface of the reflective plane; a tube arranged on the external surface of the light-incident end of the light conductive panel; a light reflecting device enclosing the large surface area of the tube, characterized in that a light coupling element is formed between the light-incident end of the light conductive panel and the tube and at least one of the light-receiving end plane and the light-emitting end face of the light coupling is formed into a non-vertical plane with the light source proceeding direction of the tube.

Still another object of the present invention is to provide backlight module, wherein any of one of the light-receiving end plane and the light-emitting end face of the light coupling is formed into a non-vertical plane with the light source proceeding direction of the tube and is a circular curvature plane which is one of the following single protruded curvature, single recessed curvature plane, single recessed-protruded curvature plane, a plurality of continuous protruded curvature planes, a plurality of continuous recessed curvature planes, a plurality of recessed protruded curvature planes, a plurality of continuous and spaced apart protruded curvature planes, a plurality of continuous and spaced recessed protruded curvature planes, a plurality of continuous but in equal degree of protruded curvature planes, a plurality of continuous and inequal degree of recessed curvature planes, a plurality of continuous and inequal degree of recessed protruded curvature planes, a plurality of continuous and spaced but inequal degree of protruded curvature planes, a plurality of continuous and spaced but inequal degree of recessed curvature planes and partial protruded curvature planes, partial recessed curvature planes.

A further object of the present invention is to provide backlight module, wherein the light-receiving end plane and the light-emitting end face of the light coupling is formed into a non-vertical plane with the light source proceeding direction of the tube and is a zig-zag plane, which is one of the following: recessed zig-zag planes, protruded zig-zag planes, continuous zig-zag planes, unequalslope of recessed zig-zag planes, unequal slope of protruded zig-zag planes, unequal slope of continuous zig-zag planes, unequal inclined angle of continuous zig-zag planes, unequal depth of continuous zig-zag planes.

Yet still another object of the present invention is to provide a backlight module, wherein the light-receiving end plane and the light-emitting end face of the light coupling is formed into a non-vertical plane with the light source proceeding direction of the tube and a zig-zag plane and circular curvature plane which is selected from a single protruded zig-zag and protruded curvature plane, a single protruded zig-zag plane and a recessed curvature plane, a single recessed zig-zag face and a protruded curvature plane, a single recessed zig-zag plane and a recessed curvature plane, a plurality of protruded zig-zag and a protruded curvature planes, a plurality of protruded zig-zag planes and recessed curvature plane, a plurality of recessed zig-zag planes and protruded curvature planes, plurality of recessed zig-zag planes and recessed curvature planes.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view of a conventional backlight module.

FIG. 2 is a schematic view showing the traveling of light of light source of FIG. 1.

FIG. 3 is a perspective exploded view of the present invention.

FIGS. 4-1 to FIGS. 4-17 show the schematic views of the variation of non vertical plane formed by any of the circular curvature of the light receiving end or light emitting end of the light coupler of the present invention.

FIGS. 5-1 to FIGS. 5-8 show the schematic views of the variation of the non vertical plane formed by any of the zig-zag faces of the light receiving end or light emitting end of the light coupler of the present invention.

FIGS. 6-1 to 6-8 show the schematic views of the variation of the non vertical planes formed by any of the circular curvature and the zig-zag faces of the light receiving end or light emitting end of the light coupler of the present invention.

FIG. 7 is a schematic view showing the light traveling of the non vertical face of the light receiving face of the light coupler of the present invention.

FIG. 8 is a schematic view of the emitted light light-field of the light conductive panel of the present invention.

FIG. 9 is a schematic view showing the light traveling of the non vertical face of the light emitting face of the light coupler of the present invention.

FIG. 10 is a schematic view of the light coupler of the present invention.

FIG. 11 is another preferred embodiment of the light conductive panel of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

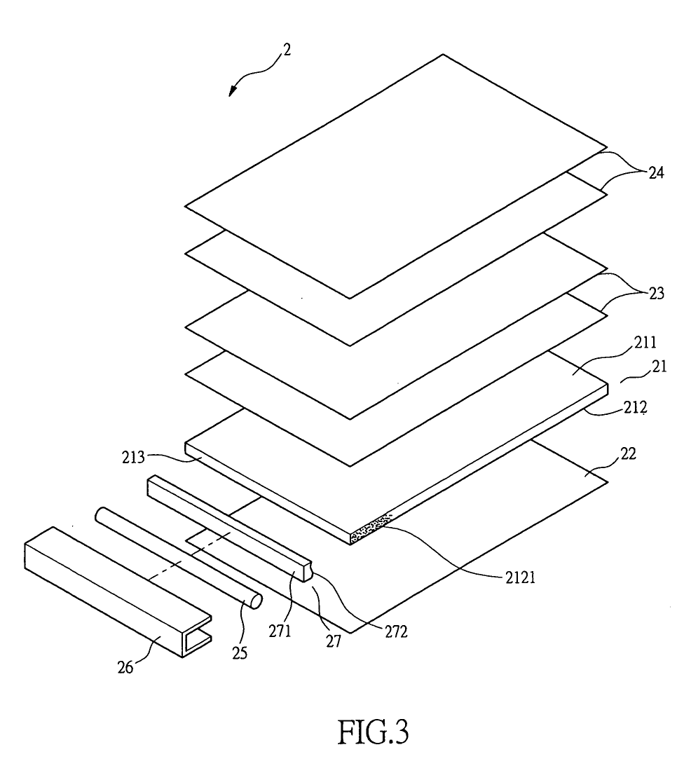

Referring to FIG. 3, there is shown a backlight module 2 comprising a light-conductive panel 21 having a light-emitting plane 211, a reflective plane 212 corresponding to the light-emitting plane 211, and at least one incident end face 213, an anti reflective end face 214 corresponding to the incident end face 213, and the reflective face 212 being provided with a plurality of light-conductive points 2121; a reflective sheet 22 mounted at the surface of the reflective face 212 of the light-conductive panel 21; a plurality of diffusion lenses 23 and focusing lenses 24 mounted at the external surface of the light-emitting pace 211 of the light-conductive panel 21; light bulb 25 mounted onto the external surface of the incident end face 213 of the light-conductive panel 21 and a light reflector 26 being used to enclose the large surface of the light bulb 25. Further, between the incident end face 213 of the light-conductive panel 21 and the light bulb 25 is provided with a light coupler 27.

The light coupler 27 is made from excellent light transitivity material, and has a light receiving end face 271 and a light emitting end face 272, the light receiving face 271 is positioned next to the light bulb 25, and the light emitting end face 272 is next to the light incident end face 213 of the light-conductive panel 21. Further, any of the face of the receiving end face 271 or the light emitting end face 272 and the light source of the light bulb direction is not vertical.

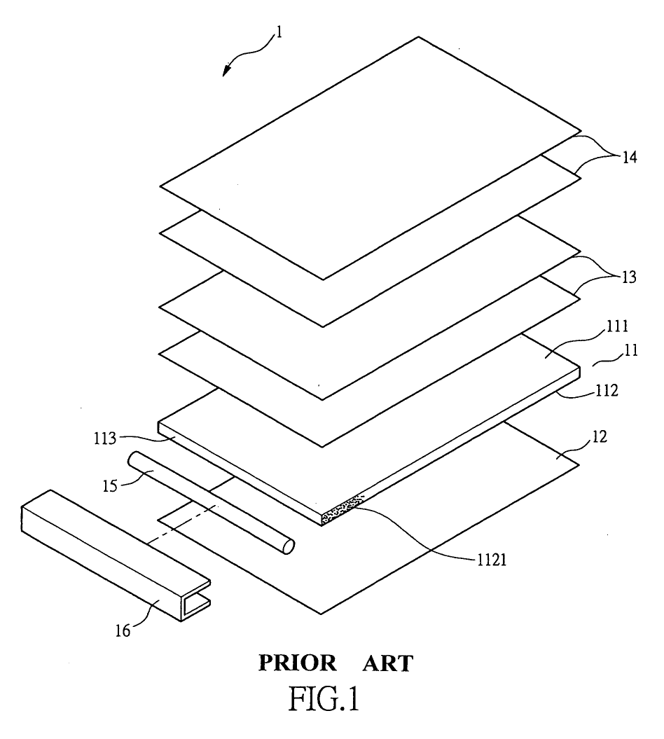

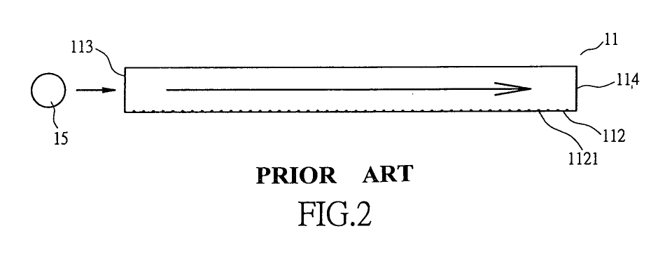

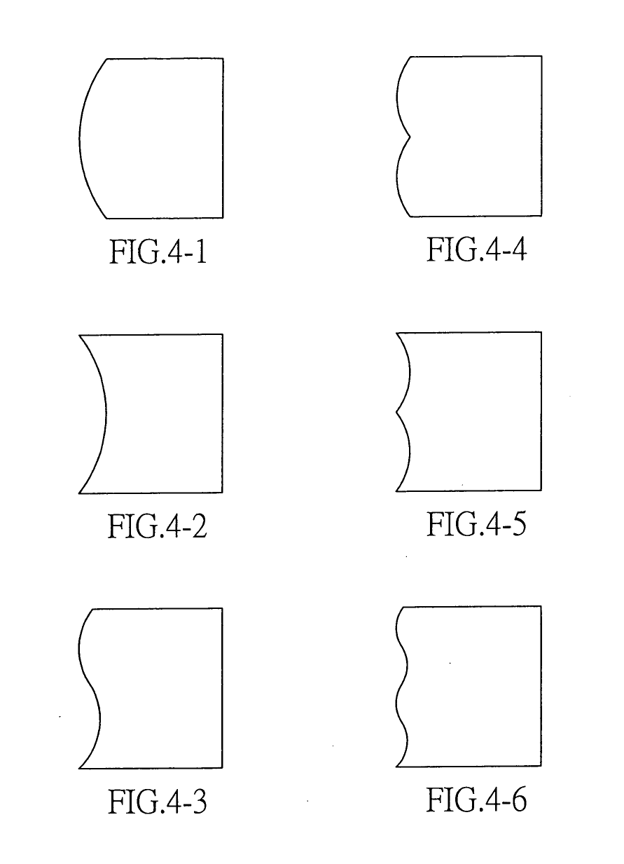

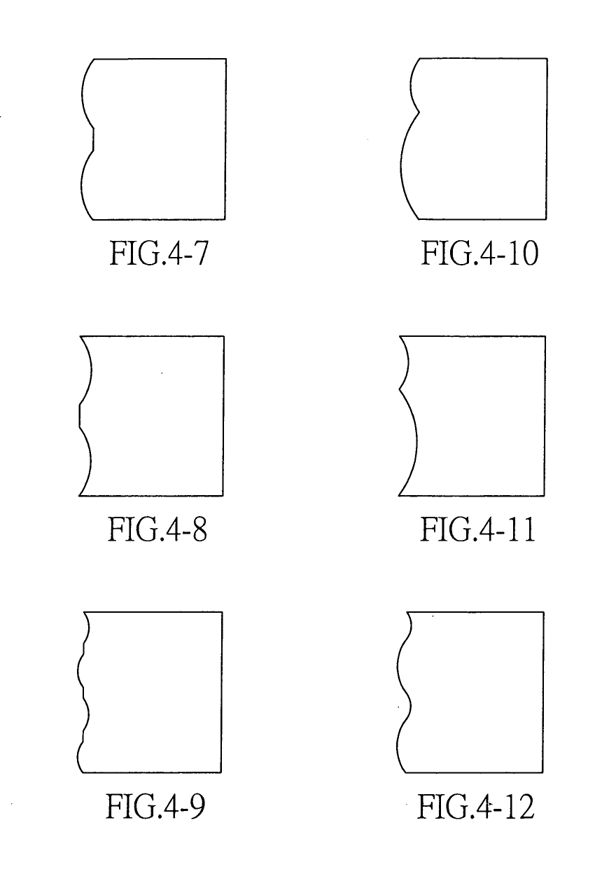

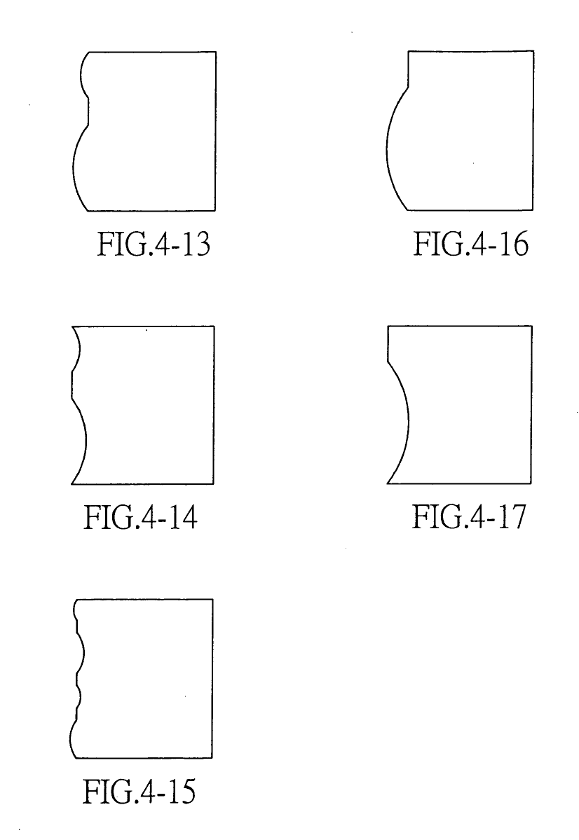

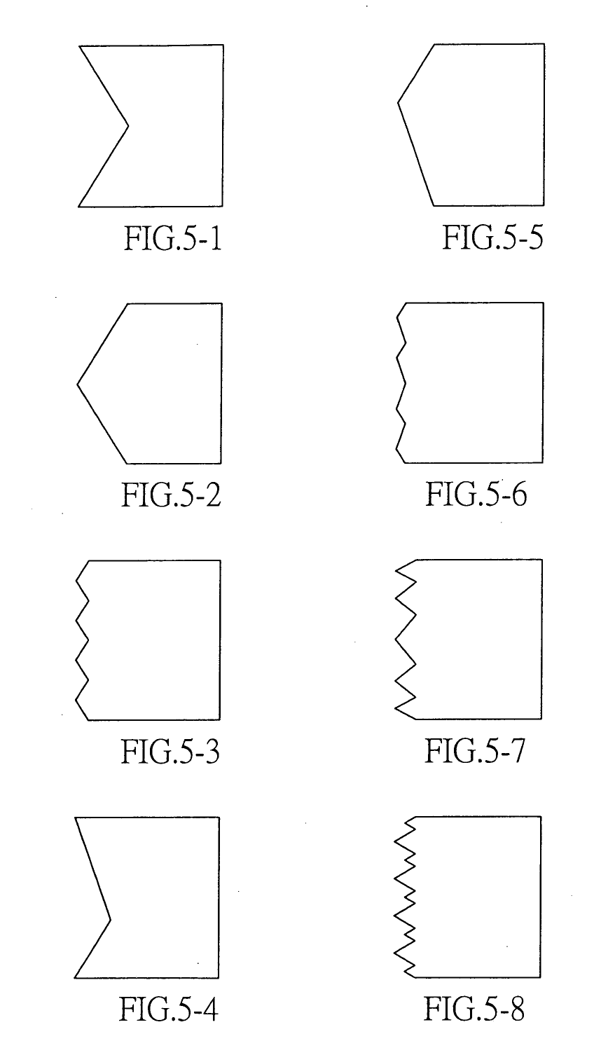

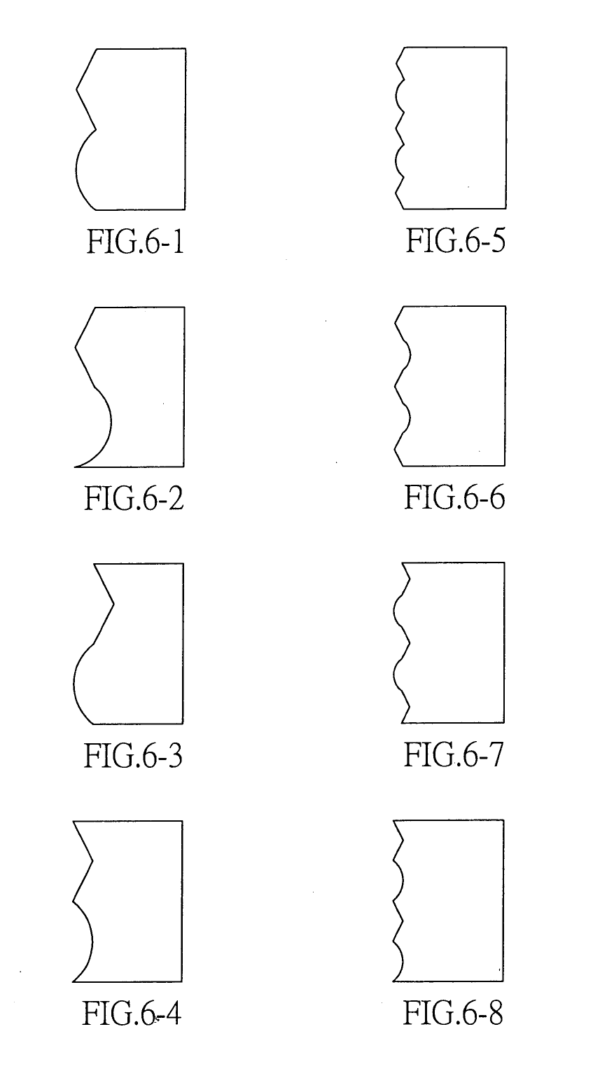

As shown in FIG. 4, any of the face of the receiving end face 271, or the light emitting end of the light coupler 27 is a non vertical, and if it is circular curvature shapes, it can vary as that shown in FIGS. 4-1 to 4-17, and in sequence, there are:

any of one of the light-receiving end planes and the light-emitting end faces of the light coupling is formed into a non-vertical plane with the light source proceeding direction of the tube and is a circular curvature plane which is one of the following single protruded curvature, single recessed curvature plane, single recessed-protruded curvature plane, a plurality of continuous protruded curvature planes, a plurality of continuous recessed curvature planes, a plurality of recessed protruded curvature planes, a plurality of continuous and spaced apart protruded curvature planes, a plurality of continuous and spaced recessed protruded curvature planes, a plurality of continuous but in equal degree of protruded curvature planes, a plurality of continuous and inequal degree of recessed curvature planes, a plurality of continuous and inequal degree of recessed protruded curvature planes, a plurality of continuous and spaced but inequal degree of protruded curvature planes, a plurality of continuous and spaced but inequal degree of recessed curvature planes and partial protruded curvature planes, partial recessed curvature planes.

If any of the face of the receiving end face 271 or the light emitting end 272 of the light coupler is non vertical but zig-zag shape, the variations are shown in FIGS. 5-1 to 5-8, as follows:

the light-receiving end plane and the light-emitting end face of the light coupling is formed into a non-vertical plane with the light source proceeding direction of the tube and as a zig-zag plane, which is one of the following: recessed zig-zag plane, protruded zig-zag plane, continuous zig-zag plane, unequal slope of recessed zig-zag planes, unequal slope of protruded zig-zag planes, unequal slope of continuous zig-zag planes, unequal inclined angle of continuous zig-zag planes, unequal depth of continuous zig-zag planes.

Further, if any of the light receiving end face 271 or the light-emitting end face 272 is a non vertical shape but can be of zig-zag shape or circular curvature shape, the variations are shown in FIGS. 6-1 to 6-8, such as the light-receiving end plane and the light-emitting end face of the light coupling is formed into a non-vertical plane with the light source proceeding direction of the tube and its zig-zag plane and circular curvature plane which is selected from a single protruded zig-zag and protruded curvature plane, a single protruded zig-zag plane and a recessed curvature plane, a single recessed zig-zag face and a protruded curvature plane, a single recessed zig-zag plane and a recessed curvature plane, a plurality of protruded zig-zag and a protruded curvature planes, a plurality of protruded zig-zag planes and recessed curvature plane, a plurality of recessed zig-zag planes and protruded curvature planes, plurality of recessed zig-zag planes and recessed curvature planes.

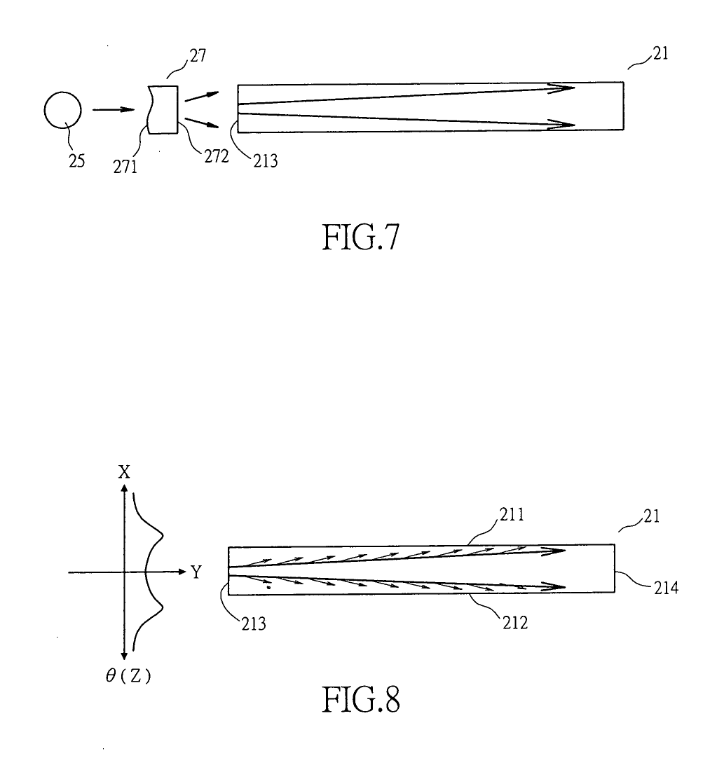

As shown in FIG. 7, if the light receiving end face 271 is non vertical (as shown by FIG. 4-3) and when the light source of the light bulb 25 is emitted onto the light receiving end face 271, the refracted light source will travel to the interior of the light coupler 27, and exist from the light emitting end 272 and then via the emitting end face 213 to the interior of the light-conductive panel 21. At this point of time, the light source leaving the light coupler 27 is not emitted to the light-conductive panel 21 in parallel but approaches the light emitting face 211 of the light conductive panel 21 and the reflective face 212 towards the interior of the light conductive panel 21 and the incident light light field distribution angle is changed, as shown in FIG. 8. This will greatly reduce the leaked light source of the anti reflective end face 214 and the effectiveness of the light source is fully utilized.

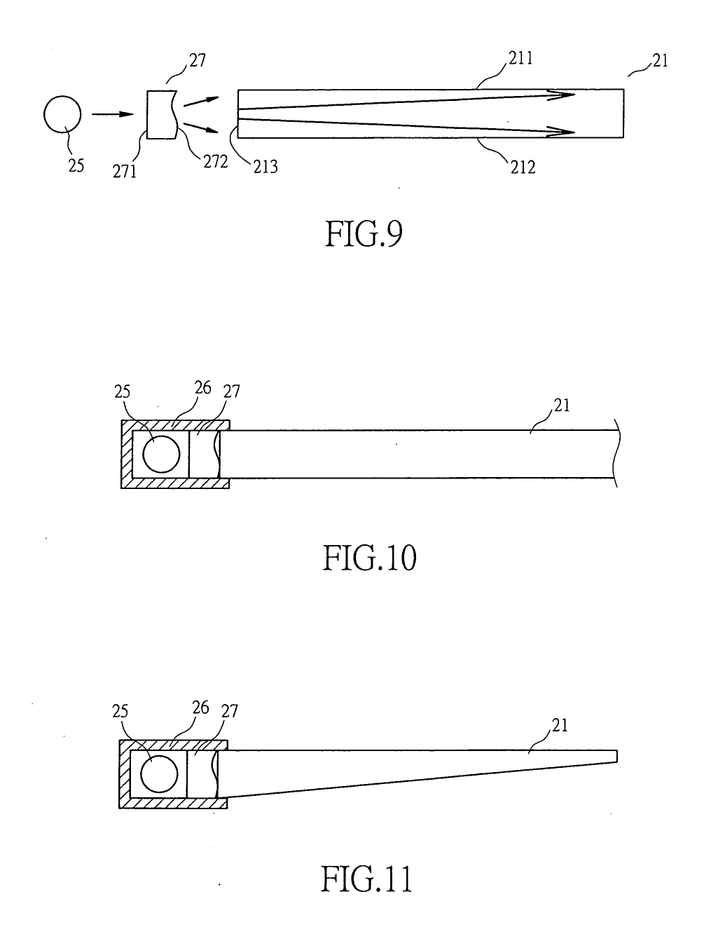

As shown in FIG. 9, if the light-emitting end face 272 is non-vertical (shown in FIG. 4-3), the light source of the light bulb 25 is parallel to the light coupler 27, but when light source passes the light emitting end face 272, the light source is refracted and proceeded to the light-emitting face 211 and the reflective face 212, and the angle of the incident light field is changed and the leakage of light source is reduced. Thus, the effectiveness of the light source is fully utilized.

In application, as shown in FIG. 10, the light coupler 27 is positioned between the light bulb 25 and the light conductive panel 21. The reflector 26 is used to secure the light bulb 25, the coupler 27 and the light conductive panel 21. The light conductive panel 21 other than rectangular shape, it can be other shapes such as wedge shape as shown in FIG. 11.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A backlight module device comprising
a light conductive panel having a light-emitting plane, a light reflective plane corresponding to the position of the light-emitting plane; and at least a light-incident plane;
a reflective sheet arranged on the external surface of the reflective plane;
a tube arranged on the external surface of the light-incident end of the light conductive panel;
a light reflecting device enclosing the large surface area of the tube, characterized in that a light coupling element is formed between the light-incident end of the light conductive panel and the tube and at least one of the light-receiving end planes and the light-emitting end face of the light coupling is formed into a non-vertical plane with the light source proceeding direction of the tube.

2. The backlight module device of claim 1, wherein any of one of the light-receiving end planes and the light-emitting end face of the light coupling is formed into a non-vertical plane with the light source proceeding direction of the tube and is a circular curvature plane which is one of the following single protruded curvature, single recessed curvature plane, single recessed-protruded curvature plane, a plurality of continuous protruded curvature planes, a plurality of continuous recessed curvature planes, a plurality of recessed protruded curvature planes, a plurality of continuous and spaced apart protruded curvature planes, a plurality of continuous and spaced recessed protruded curvature planes, a plurality of continuous but in equal degree of protruded curvature planes, a plurality of continuous and inequal degree of recessed curvature planes, a plurality of continuous and inequal degree of recessed protruded curvature planes, a plurality of continuous and spaced but inequal degree of protruded curvature plane, a plurality of continuous and spaced but inequal degree of recessed curvature planes and partial protruded curvature planes, partial recessed curvature planes.

3. The backlight module device of claim 1, wherein the light-receiving end plane and the light-emitting end face of the light coupling is formed into a non-vertical plane with the light source proceeding direction of the tube and is a zig-zag plane, which is one of the following:
recessed zig-zag plane, protruded zig-zag plane, continuous zig-zag planes, unequalslope of recessed zig-zag planes, unequal slope of protruded zig-zag planes, unequal slope of continuous zig-zag planes, unequal inclined angle of continuous zig-zag planes, unequal depth of continuous zig-zag planes.

4. The backlight module device of claim 1, wherein the light-receiving end plane and the light-emitting end face of the light coupling is formed into a non-vertical plane with the light source proceeding direction of the tube and its zig-zag plane and circular curvature plane which is selected from a single protruded zig-zag and protruded curvature plane, a single protruded zig-zag plane and a recessed curvature plane, a single recessed zig-zag face and a protruded curvature plane, a single recessed zig-zag plane and a recessed curvature plane, a plurality of protruded zig-zag and a protruded curvature plane, a plurality of protruded zig-zag planes and recessed curvature planes, a plurality of recessed zig-zag planes and protruded curvature planes, plurality of recessed zig-zag planes and recessed curvature plane.

5. The backlight module device of claim 1, wherein the light-coupling device is enclosed and secured by a light reflecting device.

6. The backlight module device of claim 1, wherein the light-emitting plane of the light-conductive panel is formed from unequal number of diverging and converging lenses.

7. The backlight module device of claim 1, wherein the reflective plane of the light-conductive plane is arranged with numbers of densely distributed light-conductive points.

8. The backlight module device of claim 1, wherein the physical shape of the light-conductive panel is either rectangular, or wedge shape.
